(19) United States
(12) Patent Application Publication
(10) Pub. No.: US 2011/0090348 A1
(43) Pub. Date: Apr. 21, 2011

(54) IMAGING SYSTEM AND IMAGING METHOD THEREFOR

(75) Inventor: Takenori Tsukikawa, Yokohama-shi (JP)

(73) Assignee: CANON KABUSHIKI KAISHA, Tokyo (JP)

(21) Appl. No.: 12/892,260

(22) Filed: Sep. 28, 2010

(30) Foreign Application Priority Data
Oct. 20, 2009 (JP) 2009-241885

(51) Int. Cl. H04N 5/225; H04N 5/228

(52) U.S. Cl. 348/207.2; 348/222.1; 348/E05.024

(57) ABSTRACT

An imaging system includes one or more imaging apparatuses. The imaging system manages sets of setting values each including imaging parameters, and extracts imaging parameters having been used in imaging from the image data captured by the imaging apparatus. Then, the imaging system compares the managed imaging parameters and the extracted imaging parameters, and issues a warning to the user and instructs the imaging apparatus to invalidate imaging processing if the imaging parameters are different from each other.

### BACKGROUND OF THE INVENTION

1. Field of the Invention

The present invention relates to an imaging system and an imaging method therefor.

2. Description of the Related Art

A system that assists in imaging work displays the image data captured by an imaging apparatus, and other information pertaining to imaging. Thus, the user can easily perform, for example, confirmation of image data, exposure in imaging, confirmation of imaging parameters such as the shutter speed and the ISO sensitivity, and image data correction by image processing.

To confirm imaging parameters, the user determines whether, for example, the imaging parameters having been used in imaging are appropriate. However, if, for example, an imaging parameter is changed despite the intention of the user during imaging, it is difficult to notify the user to that effect.

A technique disclosed in Japanese Patent Laid-Open No. 2006-180404 is known to overcome such a problem. In this technique, imaging parameters for use in imaging are managed in advance. Upon this management, the imaging parameters for use in imaging and information added to the image data captured by the imaging apparatus are compared. If the comparison result shows that the values are different from each other, a warning is issued to the user.

Also, in imaging work, image processing is generally performed to correct the captured image data. This is to correct a photo generated from image data into a high-quality one, thereby providing a value-added photo to the customer. In this regard, a technique disclosed in Japanese Patent Laid-Open No. 2005-033255 is known. In this technique, an imaging apparatus obtains image data and the imaging conditions such as the brightness and the color temperature prior to imaging. The captured image data, and the imaging conditions under which this data is captured, for example, are transmitted to a development site. Thus, in the development site having received this information, development processing and image processing are performed based on the information, and image data is printed. The printed sample is evaluated in a photographic site. If the evaluation result is unsatisfactory, image processing which meets a demand from the evaluator is performed again in the development site. The image processing conditions are determined by repeating the above-mentioned operation. Also, the determined image processing conditions are held in the development site for each set of imaging conditions.

In the technique described in Japanese Patent Laid-Open No. 2006-180404, the imaging parameters managed in advance must be manually set for the imaging apparatus prior to use. Hence, it is not certain whether the imaging parameters are accurately set. Furthermore, if the imaging parameters managed in advance are not accurately set, a warning is issued to the user, but nonetheless imaging takes place if he or she is unaware of the warning.

Although the image processing conditions are determined in advance in the technique described in Japanese Patent Laid-Open No. 2005-033255, the image processing result can be referred to only after printing, so this technique is inconvenient in use. Also, image processing items cannot be exclusively changed under the same imaging conditions.

### SUMMARY OF THE INVENTION

The present invention provides a technique which solves at least one of the above-mentioned problems.

According to a first aspect of the present invention, there is provided an imaging system including at least one imaging apparatus, comprising: a management unit configured to manage sets of setting values each including imaging parameters; an extraction unit configured to extract imaging parameters having been used in imaging from image data captured by the imaging apparatus; a comparison unit configured to compare the imaging parameters managed by the management unit, and the imaging parameters extracted by the extraction unit; a warning unit configured to issue a warning to a user if the result of comparison by the comparison unit shows that the imaging parameters are different from each other; and an instruction unit configured to instruct the imaging apparatus to invalidate imaging processing if the result of comparison by the comparison unit shows that the imaging parameters are different from each other.

According to a second aspect of the present invention, there is provided an imaging system including at least one imaging apparatus, comprising: a management unit configured to manage sets of setting values which associate imaging parameters, image processing items, and imaging purposes; an instruction unit configured to instruct the imaging apparatus to perform imaging based on the imaging parameters associated with an imaging purpose designated by a user; and an image processing unit configured to process image data captured by the imaging apparatus, based on the image processing items associated with the imaging purpose designated by the user and the imaging parameters having been used in imaging of the imaging apparatus.

According to a third aspect of the present invention, an imaging method for an imaging system including at least one imaging apparatus, comprising: managing sets of setting values each including imaging parameters; extracting imaging parameters having been used in imaging from image data captured by the imaging apparatus; comparing the managed imaging parameters and the extracted imaging parameters; issuing a warning to a user if the result of comparison shows that the imaging parameters are different from each other; and instructing the imaging apparatus to invalidate imaging processing if the result of comparison shows that the imaging parameters are different from each other.

According to a fourth aspect of the present invention, an imaging method for an imaging system including at least one imaging apparatus, comprising: managing sets of setting values which associate imaging parameters, image processing items, and imaging purposes; instructing the imaging apparatus to perform imaging based on the imaging parameters associated with an imaging purpose designated by a user; and processing image data captured by the imaging apparatus, based on the image processing items associated with the imaging purpose designated by the user and the imaging parameters having been used in imaging of the imaging apparatus.

Further features of the present invention will become apparent from the following description of exemplary embodiments with reference to the attached drawings.

### BRIEF DESCRIPTION OF THE DRAWINGS

FIG. 1 is a flowchart showing an example of the sequence of imaging work which takes place in a photographic site;

FIG. 2 is a block diagram showing an example of the entire configuration of an imaging system according to an embodiment of the present invention;

FIG. 3 is a flowchart showing an example of the sequence of processing in the imaging system shown in FIG. 2;

FIG. 4 is a table showing an example of the layout of a table according to the embodiment;

FIG. 5 is a table showing an example of the layout of a table according to the embodiment;

FIG. 6 is a view showing an example of the arrangement of a display screen according to the embodiment;

FIGS. 7A and 7B are flowcharts showing an example of the sequence of processing in the imaging system shown in FIG. 2;

FIG. 8 is a view showing an example of the arrangement of a display screen according to the embodiment; and

FIG. 9 is a flowchart showing an example of the sequence of processing in the imaging system shown in FIG. 2.

### DESCRIPTION OF THE EMBODIMENTS

An exemplary embodiment(s) of the present invention will now be described in detail with reference to the drawings. It should be noted that the relative arrangement of the components, the numerical expressions and numerical values set forth in these embodiments do not limit the scope of the present invention unless it is specifically stated otherwise.

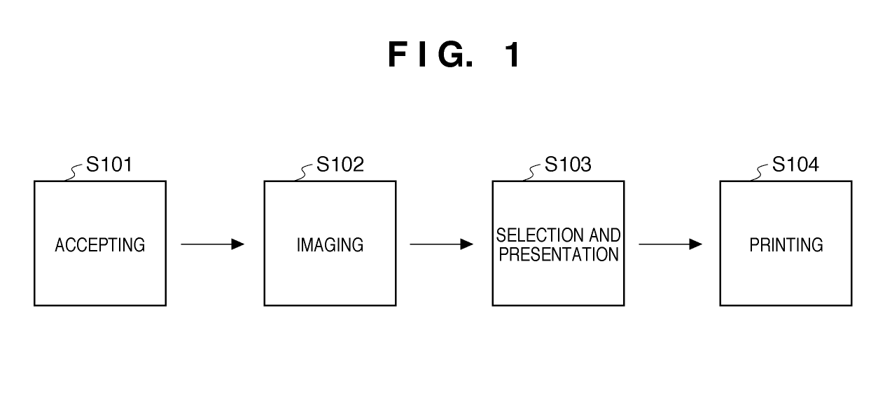

An example of the sequence of imaging work which takes place in a photographic site (for example, a photo shop or a photographic studio) will be described first with reference to FIG. 1.

In the photographic site, a customer is accepted first (S101). In this process, if the accepted customer is a new customer, a new customer ID is issued for him or her and an accepting ID is then issued. If the accepted customer is an existing customer, his or her customer ID is obtained by referring to his or her past history of coming to the shop, and an accepting ID is then issued.

After the accepting, the customer is imaged (S102). At this time, the customer changes into a desired costume. After that, the user images the customer with a composition and hue suited to the imaging purpose. Upon completion of the imaging, selection and presentation take place (S103). In this process, the customer refers to a plurality of captured images, and selects one of them. In this case, while actually referring to the captured image data via, for example, a monitor, the customer selects an image that he or she wants to buy, and places the selected image on a commercial material that he or she wants to buy.

Lastly, the selection and presentation output result is printed on actual paper (S104). The printing takes place at the photographic site in some cases, while it takes place at a site other than the photographic site in other cases, depending on the scale and policy of the photographic site. However, the printing does not take place if only the captured image data is provided to the customer. The foregoing description is concerned with an example of the sequence of imaging work.

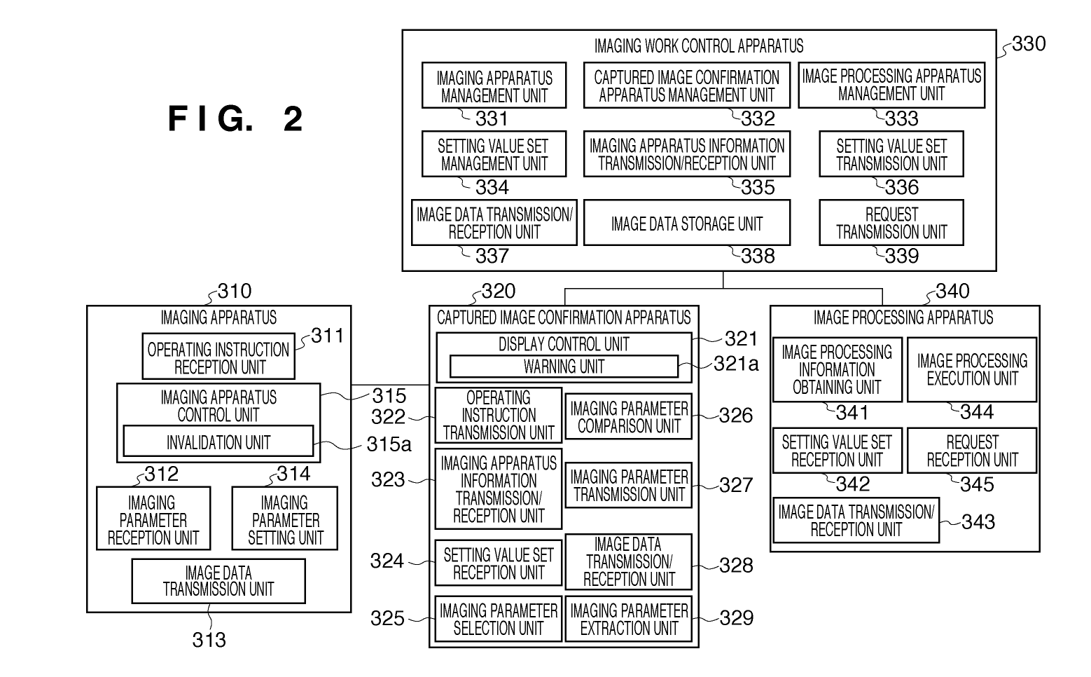

FIG. 2 is a block diagram showing an example of the entire configuration of an imaging system according to an embodiment of the present invention.

The imaging system includes an imaging apparatus 310, captured image confirmation apparatus 320, imaging work control apparatus 330, and image processing apparatus 340. The captured image confirmation apparatus 320, imaging work control apparatus 330, and image processing apparatus 340 are communicably connected to each other via, for example, a USB (Universal Serial Bus) or a LAN (Local Area Network). The communication protocol used may be, for example, TCP/IP (Transmission Control Protocol/Internet Protocol).

Also, the imaging apparatus 310 and captured image confirmation apparatus 320 are communicably connected to each other via, for example, a USB (Universal Serial Bus) or a LAN (Local Area Network). The communication protocol used may be, for example, PTP (Picture Transfer Protocol) or PTP/IP (Picture Transfer Protocol/Internet Protocol). The communication between these apparatuses may be wired or wireless communication.

The imaging apparatus 310 includes, as its functional constituent elements, an operating instruction reception unit 311, imaging parameter reception unit 312, image data transmission unit 313, imaging parameter setting unit 314, and imaging apparatus control unit 315.

The operating instruction reception unit 311 receives an operating instruction (a remote operating instruction) from the outside (for example, the captured image confirmation apparatus 320). The imaging apparatus control unit 315 controls the operation of the imaging apparatus 310 in accordance with the operating instruction received by the operating instruction reception unit 311. The imaging apparatus control unit 315 includes an invalidation unit 315a. The invalidation unit 315a inhibits imaging processing in the imaging apparatus 310 in accordance with the operating instruction (imaging processing invalidation) received by the operating instruction reception unit 311.

The imaging parameter reception unit 312 receives imaging parameters from the outside. The imaging parameters received by the imaging parameter reception unit 312 are set as those of the imaging apparatus 310 by the imaging parameter setting unit 314. The image data transmission unit 313 transmits the captured image data to the outside (for example, the captured image confirmation apparatus 320).

The captured image confirmation apparatus 320 will be described next. The captured image confirmation apparatus 320 includes, as its functional constituent elements, a display control unit 321, operating instruction transmission unit 322, imaging apparatus information transmission/reception unit 323, setting value set reception unit 324, and imaging parameter selection unit 325. The captured image confirmation apparatus 320 also includes an imaging parameter comparison unit 326, imaging parameter transmission unit 327, image data transmission/reception unit 328, and imaging parameter extraction unit 329.

The display control unit 321 presents various types of screens to a display device (not shown). The image data transmission/reception unit 328 receives the image data sent from the imaging apparatus 310, or transmits the image data to the imaging work control apparatus 330. The display control unit 321 includes a warning unit 321a. If, for example, an imaging parameter is changed upon, for example, erroneous operation, the warning unit 321a warns the user to that effect. Although a case in which the user is warned through display will be taken as an example in this embodiment, the warning method is not limited to this. The warning may be performed using, for example, audio guidance or an alarm sound.

The operating instruction transmission unit 322 transmits a command for remote operation to the imaging apparatus 310. The operating instruction transmission unit 322 transmits, for example, an imaging instruction or an operating instruction. The imaging apparatus information transmission/reception unit 323 exchanges imaging apparatus information with the imaging work control apparatus 330. This is to obtain information on the imaging apparatus 310.

The setting value set reception unit 324 receives a set of setting values including imaging parameters. This is to cope with a situation in which, for example, an imaging parameter is changed upon, for example, erroneous operation. Note that the set of setting values are formed from information including imaging parameters which can be set for the imaging apparatus 310, image processing items to be executed for the captured image data, and image processing parameters.

The imaging parameter selection unit 325 selects settable imaging parameters in accordance with the capacity of the imaging apparatus 310 from the imaging parameters (set of setting values) received by the setting value set reception unit 324. The imaging parameter extraction unit 329 extracts the imaging parameters from the image data received by the image data transmission/reception unit 328. The imaging parameter comparison unit 326 compares the imaging parameters managed in advance and those having been used in imaging. The imaging parameter transmission unit 327 transmits the imaging parameters to the imaging apparatus 310.

The imaging work control apparatus 330 will be described next. The imaging work control apparatus 330 includes, as its functional constituent elements, an imaging apparatus management unit 331, captured image confirmation apparatus management unit 332, image processing apparatus management unit 333, setting value set management unit 334, and imaging apparatus information transmission/reception unit 335. The imaging work control apparatus 330 also includes a setting value set transmission unit 336, image data transmission/reception unit 337, image data storage unit 338, and request transmission unit 339.

The imaging apparatus management unit 331 manages the imaging apparatus 310, the captured image confirmation apparatus management unit 332 manages the captured image confirmation apparatus 320, and the image processing apparatus management unit 333 manages the image processing apparatus 340. The image data storage unit 338 stores the image data captured in imaging work. The setting value set management unit 334 manages the above-mentioned set of setting values.

The setting value set transmission unit 336 transmits a set of setting values to the captured image confirmation apparatus 320 and image processing apparatus 340. The imaging apparatus information transmission/reception unit 335 transmits/receives imaging apparatus information managed by the imaging apparatus management unit 331. The request transmission unit 339 transmits an image processing request to the image processing apparatus 340. The image data transmission/reception unit 337 receives the image data captured by the imaging apparatus 310, or transmits the image data to the image processing apparatus 340.

The image processing apparatus 340 will be described next. The image processing apparatus 340 includes, as its functional constituent elements, an image processing information obtaining unit 341, setting value set reception unit 342, image data transmission/reception unit 343, image processing execution unit 344, and request reception unit 345.

The request reception unit 345 receives an image processing request from the imaging work control apparatus 330, and the setting value set reception unit 342 receives the set of setting values. The image data transmission/reception unit 343 receives the image data sent together with the image processing request, or transmits the processed image data.

The image processing information obtaining unit 341 obtains image processing items and image processing parameters from the set of setting values received by the setting value set reception unit 342. The image processing execution unit 344 executes image processing corresponding to the image processing items obtained by the image processing information obtaining unit 341. Note that this image processing is performed based on the image processing parameters obtained from the set of setting values.

The foregoing description is concerned with an example of the entire configuration of the imaging system. However, this system configuration is merely an example, and the present invention is not limited to this. For example, these apparatuses need not always be physical apparatuses, and, for example, the imaging work control apparatus 330 and image processing apparatus 340 may be implemented as a single apparatus.

A computer is built into each of the imaging apparatus 310, captured image confirmation apparatus 320, imaging work control apparatus 330, and image processing apparatus 340, which have been described earlier. The computer includes a main control means such as a CPU and storage means such as a ROM (Read Only Memory), a RAM (Random Access Memory), and an HDD (Hard Disk Drive). The computer also includes, for example, input/output means such as a keyboard, a mouse, a display, and buttons or a touch panel. These constituent means are connected via, for example, a bus, and controlled by executing a program stored in the storage means by the main control means.

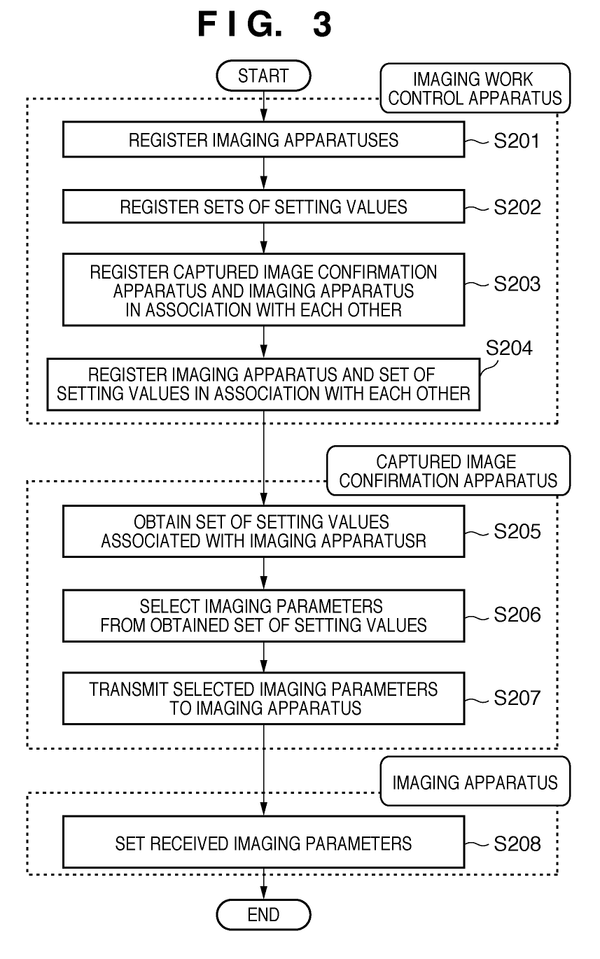

An example of the sequence of processing in the imaging system shown in FIG. 2 will be described next with reference to FIG. 3. The sequence of preliminary processing performed before actual imaging will be taken as an example first herein.

First, the user uses the imaging work control apparatus 330 to register imaging apparatuses 310 to be used in imaging. After the user performs the operation of registering the imaging apparatuses 310, the imaging work control apparatus 330 uses the imaging apparatus management unit 331 to register and manage the imaging apparatuses 310 (S201).

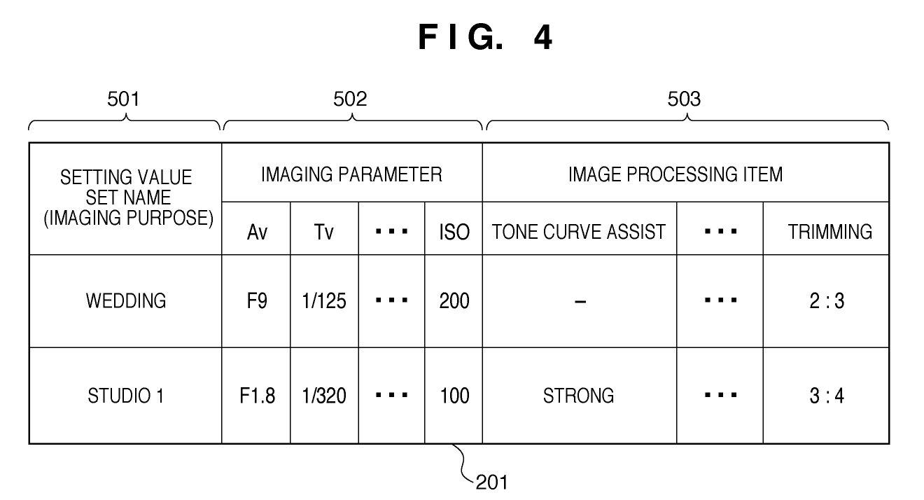

Subsequently, the user registers sets of setting values. A set of setting values are registered for, for example, each imaging purpose. After the user performs the operation of registering the sets of setting values, the imaging work control apparatus 330 uses the setting value set management unit 334 to register and manage the sets of setting values (S202). The sets of setting values are managed using, for example, a table shown in FIG. 4.

As shown in FIG. 4, a setting value set name 501 not only is used to uniquely identify each set of setting values (each record) but also indicates the imaging purpose. The imaging purpose may not only be information pertaining to objects, such as “Wedding”, but also be information pertaining to the trader who engages in imaging work, such as “Studio 1” in the photographic site or “User A”. An imaging parameter 502 indicates imaging parameters to be used in imaging by the imaging apparatuses 310. An image processing item 503 indicates image processing items to be performed for the image data captured by the imaging apparatuses 310.

Referring back to FIG. 3, upon completion of the registration of the sets of setting values, the captured image confirmation apparatus 320 uses the imaging apparatus information transmission/reception unit 323 to obtain pieces of information on the imaging apparatuses 310 from the imaging work control apparatus 330. The captured image confirmation apparatus 320 selects information on one imaging apparatus 310 from the obtained pieces of information on one or more imaging apparatuses 310. Thus, the imaging apparatuses 310 and the captured image confirmation apparatus 320 are associated with each other.

At this time, information which associates the captured image confirmation apparatus 320 and the imaging apparatus 310 with each other is sent from the captured image confirmation apparatus 320 to the imaging work control apparatus 330. Thus, the imaging work control apparatus 330 uses the captured image confirmation apparatus management unit 332 to manage this association information (S203). Note that a plurality of imaging apparatuses 310 may be associated with a single captured image confirmation apparatus 320.

After that, the captured image confirmation apparatus 320 uses the setting value set reception unit 324 to obtain the sets of setting values from the imaging work control apparatus 330. A set of setting values to be used is selected for each imaging apparatus 310, and they are associated with each other. Information which associates the imaging apparatus 310 and the set of setting values with each other is sent from the captured image confirmation apparatus 320 to the imaging work control apparatus 330. Thus, the imaging work control apparatus 330 uses the imaging apparatus management unit 331 to manage the association information. Note that since the set of setting values according to this embodiment indicate the imaging purpose, the imaging apparatus 310 and the imaging purpose are associated with each other by the selection of the set of setting values.

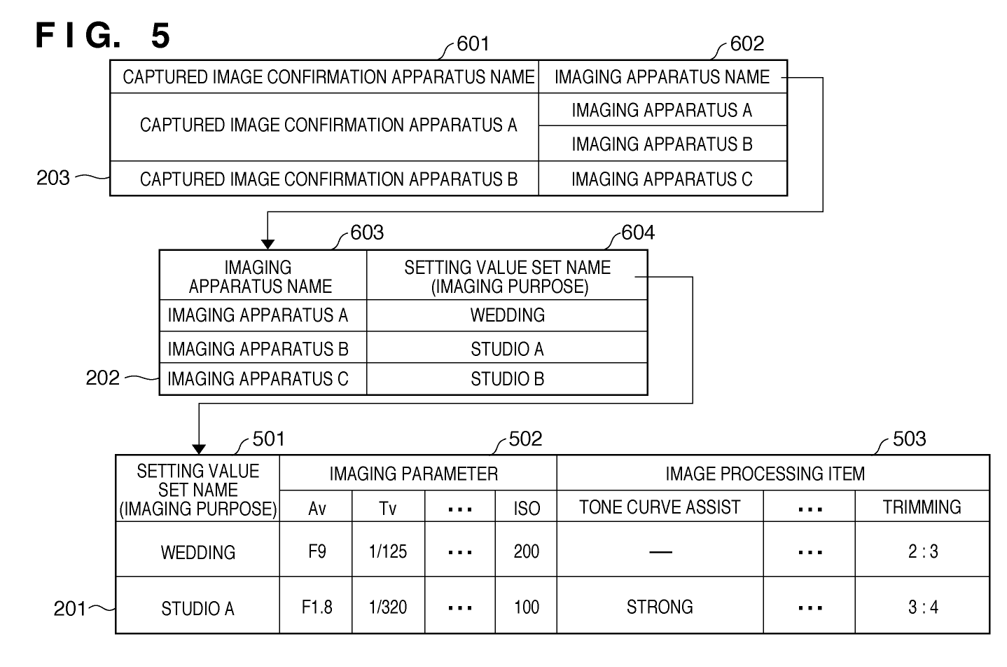

At this time, each apparatus (captured image confirmation apparatus 320 and imaging apparatus 310) is associated with the set of setting values by the above-mentioned processing (S204). More specifically, the imaging work control apparatus 330 associates these apparatuses and the set of setting values with each other using tables 201 to 203 shown in FIG. 5. Note that the table 203 is managed by the captured image confirmation apparatus management unit 332, the table 202 is managed by the imaging apparatus management unit 331, and the table 201 is managed by the setting value set management unit 334.

This association relationship will be briefly described with reference to FIG. 5. Referring to a captured image confirmation apparatus name 601 and imaging apparatus name 602 in the table 203, for example, imaging apparatuses A and B are associated with captured image confirmation apparatus A. Also, referring to an imaging apparatus name 603 and setting value set name 604 in the table 202, for example, the setting value set name 604 (wedding) is associated with imaging apparatus A. Moreover, referring to the setting value set name 501 and imaging parameter 502 in the table 203, for example, the imaging parameter 502 and image processing item 503 are associated with the setting value set name 501 (wedding). Thus, the captured image confirmation apparatus 320 can obtain, for example, imaging parameters for the imaging apparatus 310 with reference to the tables 201 to 203. In case of, for example, imaging apparatus A, the imaging parameter 502 and image processing item 503 corresponding to the setting value set name 501 (wedding) in the table 201 are obtained.

Referring back to FIG. 3, subsequently, the user connects the imaging apparatus 310 and the captured image confirmation apparatus 320 to each other. Upon this connection, the captured image confirmation apparatus 320 then repeatedly executes imaging parameter setting processing for one or more imaging apparatuses 310 associated with it.

When imaging parameter setting processing starts, the captured image confirmation apparatus 320 uses the imaging apparatus information transmission/reception unit 323 to obtain a set of setting values associated with the imaging apparatus 310 connected to it (S205). In this process, the imaging work control apparatus 330 uses the imaging apparatus information transmission/reception unit 335 to obtain a set of setting values associated with the imaging apparatus 310, and transmit the obtained set of setting values to the captured image confirmation apparatus 320.

After that, the captured image confirmation apparatus 320 uses the imaging parameter selection unit 325 to select imaging parameters from the set of setting values obtained in step S207 (S206). At this time, settable imaging parameters are selected in accordance with the capacity of the imaging apparatus 310 connected to the captured image confirmation apparatus 320. Upon completion of the selection of the imaging parameters, the captured image confirmation apparatus 320 uses the imaging parameter transmission unit 327 to transmit the selected imaging parameters to the imaging apparatus 310 (S207).

In response to this, the imaging apparatus 310 uses the imaging parameter reception unit 312 to receive the imaging parameters, and uses the imaging parameter setting unit 314 to set these parameters (S208). Then, the preliminary processing ends.

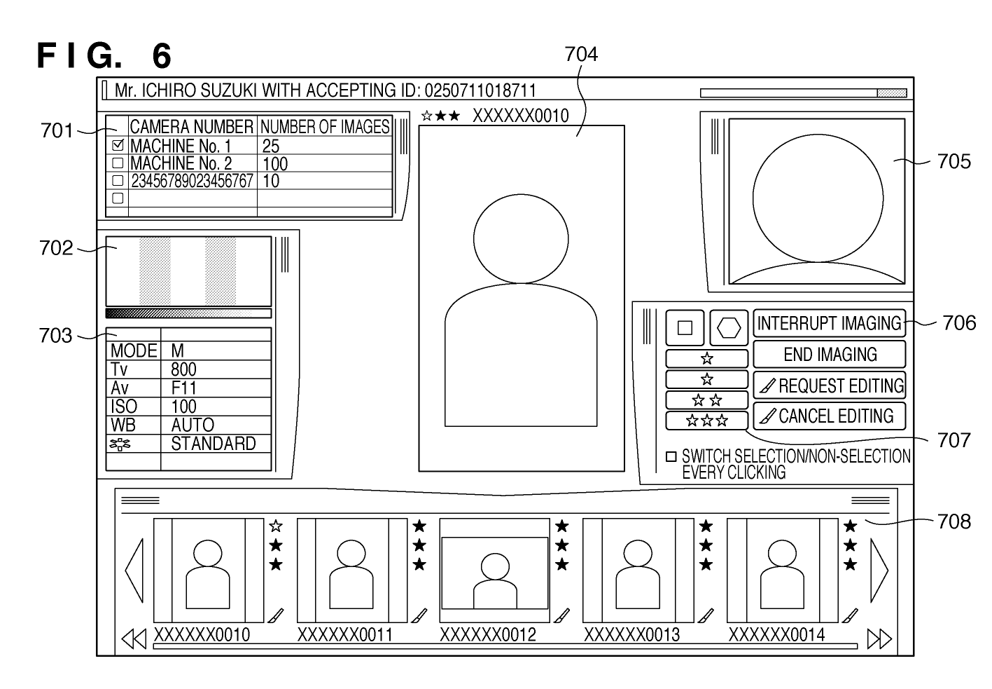

A user interface (that is, a screen) whose display is controlled by the display control unit 321 of the captured image confirmation apparatus 320 will be described next with reference to FIG. 6. A captured image confirmation screen will be taken as an example of the screen provided by the display control unit 321 herein. Note that the captured image confirmation screen is provided to allow the user to confirm the image captured by the imaging apparatus 310.

The captured image confirmation screen includes an imaging apparatus list display unit 701, image data histogram display unit 702, imaging parameter list display unit 703, image data main display unit 704, and image data sub-display unit 705. The captured image confirmation screen also includes an imaging work operation unit 706, image data evaluation unit 707, and thumbnail image display unit 708.

The imaging apparatus list display unit 701 displays a list of imaging apparatuses 310 associated with the captured image confirmation apparatus 320. In this case, the number of image data captured by each imaging apparatus 310 is displayed, in addition to the list of imaging apparatuses 310. The imaging apparatus list display unit 701 also displays information (a connection state or a disconnection state) indicating whether the imaging apparatuses 310 are connected to the captured image confirmation apparatus 320.

The image data histogram display unit 702 displays the component analysis result (the histogram in this case) of the image displayed on the image data main display unit 704. The imaging parameter list display unit 703 displays the imaging parameters at the time of capturing the image displayed on the image data main display unit 704.

The image data main display unit 704 displays the image data selected from the thumbnail image display unit 708. When imaging takes place, the image data main display unit 704 displays the image captured upon the imaging. An arbitrary image data display method such as fit display or unit-magnification display may be adopted. The entire image data is displayed in the fit display, whereas a partial region of the image is displayed in the unit-magnification display.

The image data sub-display unit 705 displays a partial region of the image data displayed on the image data main display unit 704 and, for example, the face region of a person if he or she is captured in this data. Also, in case of unit-magnification display, the image data main display unit 704 displays the entire image displayed on the image data main display unit 704. The imaging work operation unit 706 includes buttons for instructing to end and interrupt imaging.

The image data evaluation unit 707 displays evaluation for the captured image data. This evaluation is set by the user. For example, grade 0 is set for an image that the user does not want to show the customer, and grade 3 is set for an image that the user wants to use in selection and presentation work. Although four grades 0 to 3 are used as evaluation levels in the description with reference to FIG. 6, evaluation using two grades: necessary/unnecessary or six grades 0 to 5 may be used, so the number of grades of evaluation is not limited to a specific one.

The thumbnail image display unit 708 displays a list of captured images. When new imaging takes place, the latest image captured upon the imaging is added to the bottom of the image list. Also, when the user selects the imaging apparatus 310 displayed on the imaging apparatus list display unit 701, display/non-display of the image captured by the imaging apparatus 310 is changed. Each thumbnail is displayed in association with, for example, a thumbnail image, evaluation information obtained by the image data evaluation unit 707, information on editing instructed by the imaging work operation unit 706, and an arbitrary image number.

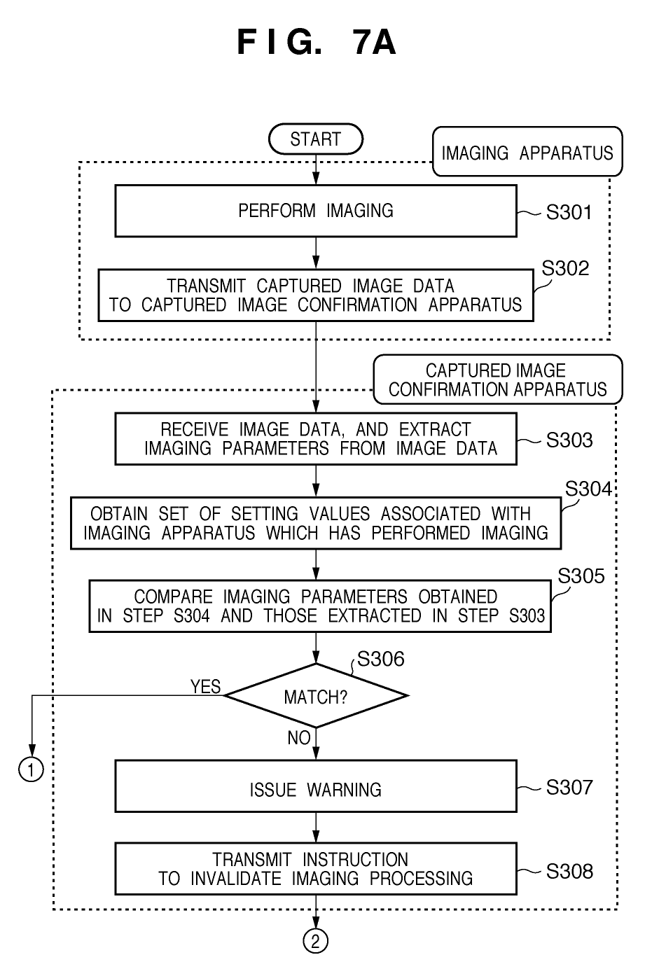

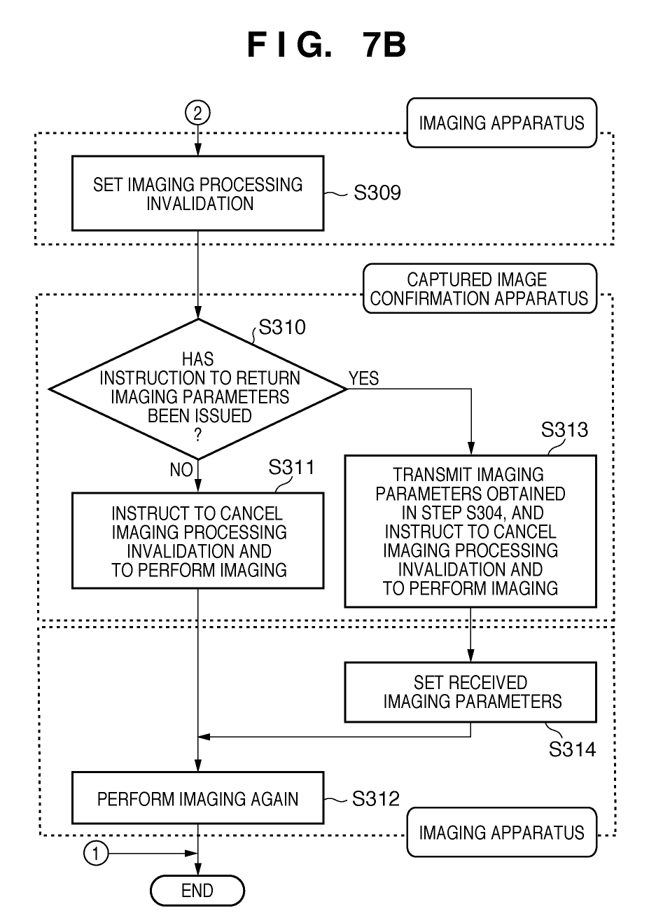

An example of the sequence of processing in the imaging system shown in FIG. 2 will be described next with reference to FIGS. 7A and 7B. The sequence of actual imaging processing will be taken as an example herein. Assume that the above-mentioned preliminary processing has already been performed.

First, the user performs imaging using an imaging apparatus 310 (S301). Upon completion of the imaging, the imaging apparatus 310 uses the image data transmission unit 313 to transmit the image data captured upon the imaging to a captured image confirmation apparatus 320 associated with it (S302). In response to this, the captured image confirmation apparatus 320 uses the image data transmission/reception unit 328 to obtain the image data, and uses the imaging parameter extraction unit 329 to extract imaging parameters from the obtained image data (S303).

At this time, the captured image confirmation apparatus 320 uses the setting value set reception unit 324 to obtain a set of setting values associated with the imaging apparatus 310, which has performed imaging in step S301, from the imaging work control apparatus 330 (S304). In obtaining the set of setting values, the imaging work control apparatus 330 uses the setting value set transmission unit 336 to transmit the requested set of setting values.

After that, the captured image confirmation apparatus 320 uses the imaging parameter comparison unit 326 to compare the imaging parameters which have been used at the time of imaging and are obtained in step S303, and imaging parameters which have predetermined values and are obtained in step S304 (S305).

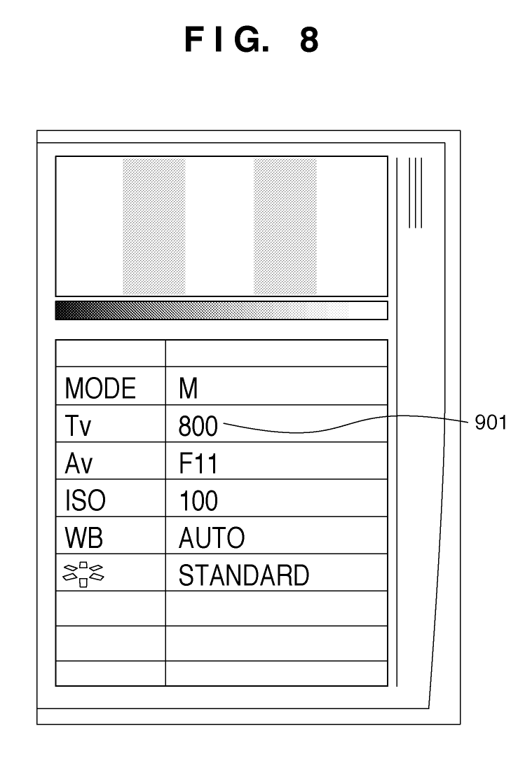

If the comparison result shows that the imaging parameters are equal to each other (YES in step S306), the processing directly ends. In contrast, if the comparison result shows that the imaging parameters are different from each other (NO in step S306), the captured image confirmation apparatus 320 uses the display control unit 321 (warning unit 321a) to display a display screen shown in FIG. 8 (S307). Thus, the user is warned of the fact that the imaging parameters are different from each other. The parameters with different values are displayed using, for example, a representation (for example, red lettering or highlighting) different from those of other images and texts.

In addition to this warning display, the captured image confirmation apparatus 320 uses the operating instruction transmission unit 322 to transmit an instruction to invalidate imaging processing to the imaging apparatus 310 (S308). Upon this transmission, the imaging apparatus 310 uses the operating instruction reception unit 311 to receive the instruction, and uses the invalidation unit 315a to set imaging processing invalidation (S309). Therefore, the user cannot release the shutter even if he or she tries to take a new image, so he or she can become aware that the imaging parameters are different from each other. With this processing, imaging does not take place with erroneous settings even if the user overlooks a warning because, for example, he or she concentrates his or her mind on imaging.

The user determines whether the imaging parameters are to be returned to the initial settings (that is, predetermined values set in advance). If the user instructs not to return the imaging parameters to the predetermined values (NO in step S310), the instruction is sent from the imaging apparatus 310 to the captured image confirmation apparatus 320. Upon this sending, the captured image confirmation apparatus 320 uses the operating instruction transmission unit 322 to transmit an instruction to cancel the imaging processing invalidation and an imaging instruction to the imaging apparatus 310 (S311). Thus, operation of the imaging apparatus 310 is enabled, so the imaging apparatus 310 is permitted to perform imaging using the imaging parameters different from the predetermined values. After that, the imaging apparatus 310 performs imaging based on the imaging parameters (S312), and the processing ends.

In contrast, if the user instructs to return the imaging parameters to the predetermined values (YES in step S310), the captured image confirmation apparatus 320 uses the imaging parameter transmission unit 327 to transmit the imaging parameters with the predetermined values to the imaging apparatus 310. Also, the captured image confirmation apparatus 320 uses the operating instruction transmission unit 322 to transmit an instruction to cancel the imaging processing invalidation and an imaging instruction to the imaging apparatus 310 (S313).

In response to this, the imaging apparatus 310 uses the imaging parameter reception unit 312 to receive the parameters, and uses the imaging parameter setting unit 314 to set the imaging parameters to the predetermined values again (S314). Also, operation of the imaging apparatus 310 is enabled, so the imaging apparatus 310 performs imaging using the imaging parameters with the predetermined values (S312). After that, the processing ends.

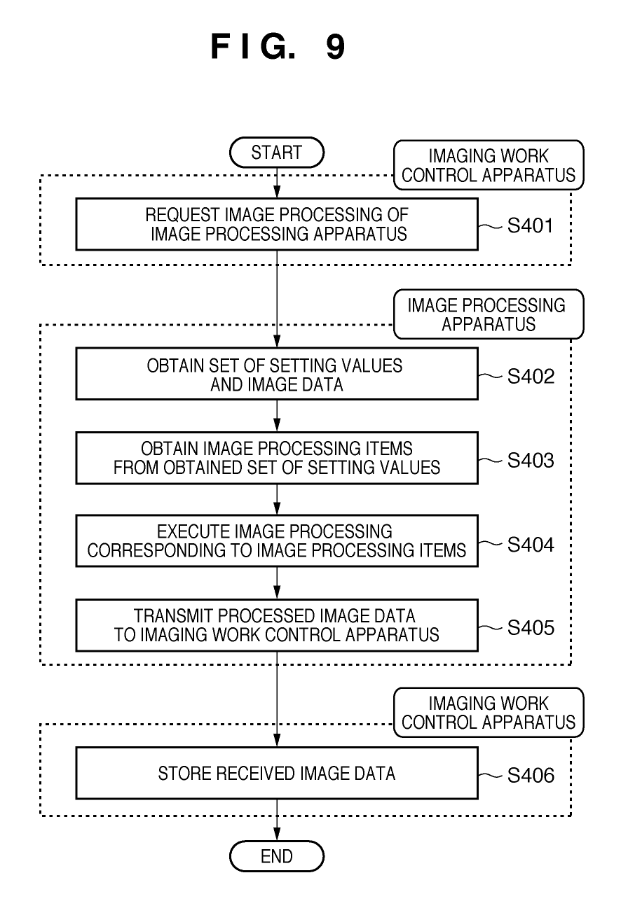

An example of the sequence of processing in the imaging system shown in FIG. 2 will be described next with reference to FIG. 9. The sequence of image processing performed after imaging will be taken as an example herein. Assume that the image processing apparatus management unit 333 of the imaging work control apparatus 330 has already registered an image processing apparatus 340 which performs image processing.

The imaging work control apparatus 330 uses the request transmission unit 339 to transmit an image processing request to the image processing apparatus 340 (S401). Note that the image processing apparatus 340 that is a request destination has been registered in the image processing apparatus management unit 333.

At this time, the image processing apparatus 340 uses the request reception unit 345 to receive the request. Upon this reception, the image processing apparatus 340 uses the setting value set reception unit 342 to receive a set of setting values from the imaging work control apparatus 330, and uses the image data transmission/reception unit 343 to receive image data from the imaging work control apparatus 330 (S402). Note that the set of setting values and the image data are sent from the setting value set transmission unit 336 and image data transmission/reception unit 337, respectively, of the imaging work control apparatus 330.

The image processing apparatus 340 uses the image processing information obtaining unit 341 to obtain image processing items from the set of setting values obtained in step S402 (S403). The image processing apparatus 340 then uses the image processing execution unit 344 to execute image processing corresponding to the obtained image processing items (S404). This image processing is performed based on the image processing parameters obtained from the set of setting values.

After that, the image processing apparatus 340 uses the image data transmission/reception unit 343 to transmit the processed image data to the imaging work control apparatus 330 (S405). The imaging work control apparatus 330 uses the image data transmission/reception unit 337 to receive the image data, and uses the image data storage unit 338 to store it (S406). Then, the processing ends.

As has been described above, according to this embodiment, even if the user has changed an imaging parameter upon erroneous operation, imaging processing by an imaging apparatus is invalidated, and a preset imaging parameter is set for the imaging apparatus again. This makes it possible to reduce imaging mistakes due to, for example, erroneous setting of an imaging parameter.

Also, a set of setting values including imaging parameters and image processing items are managed for each imaging purpose. Hence, even when, for example, imaging takes place for various purposes, the imaging parameters and image processing items of the imaging apparatus can be quickly changed. This makes it possible to shorten the operation time and to reduce setting mistakes of the user.

Moreover, imaging parameters and image processing items are managed in association with each other, and image processing is performed based on the image processing items. This makes it possible to simultaneously execute image processing during imaging work, thereby shortening the operation time. Since processed images can be presented to customers in a photographic site, the convenience for the customers improves. Since the image processing items are managed for each imaging purpose, different types of image processing can be provided even if the same imaging apparatus and imaging parameters are used.

Although an exemplary embodiment of the present invention has been described above, the present invention is not limited to the embodiment described above and shown in the drawings, and can be appropriately modified and practiced without departing from the scope of the present invention.

The present invention can be embodied as, for example, a system, an apparatus, a method, and a program or storage medium. More specifically, the present invention may be applied to a system including a plurality of devices or an apparatus including only one device.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-241885 filed on Oct. 20, 2009, which is hereby incorporated by reference herein in its entirety.

What is claimed is:

1. An imaging system including at least one imaging apparatus, comprising:
a management unit configured to manage sets of setting values each including imaging parameters;
an extraction unit configured to extract imaging parameters having been used in imaging from image data captured by the imaging apparatus;
a comparison unit configured to compare the imaging parameters managed by said management unit, and the imaging parameters extracted by said extraction unit;
a warning unit configured to issue a warning to a user if the result of comparison by said comparison unit shows that the imaging parameters are different from each other; and
an instruction unit configured to instruct the imaging apparatus to invalidate imaging processing if the result of comparison by said comparison unit shows that the imaging parameters are different from each other.

2. The system according to claim 1, further comprising
an imaging parameter transmission unit configured to transmit the imaging parameters managed by said management unit to the imaging apparatus if the result of comparison by said comparison unit shows that the imaging parameters are different from each other,
wherein said instruction unit instructs the imaging apparatus to cancel the invalidation after the imaging parameters are transmitted by said imaging parameter transmission unit.

3. The system according to claim 1, further comprising
a selection unit configured to select a settable imaging parameter in accordance with a capacity of an imaging apparatus which performs imaging from the imaging parameters managed by said management unit,
wherein said comparison unit compares the imaging parameter selected by said selection unit, and the imaging parameter extracted from said extraction unit.

4. The system according to claim 1, wherein
the sets of setting values associate said at least one imaging apparatus, imaging purposes, and the imaging parameters with each other, and
said comparison unit compares the imaging parameters associated with an imaging purpose designated by the user and an imaging apparatus which performs imaging, and the imaging parameters extracted by said extraction unit.

5. The system according to claim 1, further comprising
an image processing unit configured to process the image data captured by the imaging apparatus,
wherein
the sets of setting values associate the imaging parameters, image processing items, and imaging purposes with each other, and
said image processing unit executes the image processing based on the image processing items associated with an imaging purpose designated by the user and the imaging parameters having been used in imaging of the imaging apparatus.

6. The system according to claim 1, further comprising
a display control unit configured to display the image data captured by the imaging apparatus on a display device.

7. An imaging system including at least one imaging apparatus, comprising:
a management unit configured to manage sets of setting values which associate imaging parameters, image processing items, and imaging purposes;
an instruction unit configured to instruct the imaging apparatus to perform imaging based on the imaging parameters associated with an imaging purpose designated by a user; and
an image processing unit configured to process image data captured by the imaging apparatus, based on the image processing items associated with the imaging purpose designated by the user and the imaging parameters having been used in imaging of the imaging apparatus.

8. An imaging method for an imaging system including at least one imaging apparatus, comprising:
managing sets of setting values each including imaging parameters;
extracting imaging parameters having been used in imaging from image data captured by the imaging apparatus;
comparing the managed imaging parameters and the extracted imaging parameters;
issuing a warning to a user if the result of comparison shows that the imaging parameters are different from each other; and
instructing the imaging apparatus to invalidate imaging processing if the result of comparison shows that the imaging parameters are different from each other.

9. An imaging method for an imaging system including at least one imaging apparatus, comprising:
managing sets of setting values which associate imaging parameters, image processing items, and imaging purposes;
instructing the imaging apparatus to perform imaging based on the imaging parameters associated with an imaging purpose designated by a user; and
processing image data captured by the imaging apparatus, based on the image processing items associated with the imaging purpose designated by the user and the imaging parameters having been used in imaging of the imaging apparatus.
